(19) United States
(12) Patent Application Publication
(10) Pub. No.: US 2023/0153715 A1
(43) Pub. Date: May 18, 2023

(54) Method and System for a Service Network

(71) Applicant: Paul Hoang Pham, Orange, CA (US)

(72) Inventor: Paul Hoang Pham, Orange, CA (US)

(21) Appl. No.: 17/972,719

(22) Filed: Oct. 25, 2022

Related U.S. Application Data
(60) Provisional application No. 63/272,179, filed on Oct. 27, 2021.

(51) Int. Cl. G06Q 10/0631; G06F 3/0485; G06F 3/04847; G06F 3/0482

(52) U.S. Cl. CPC G06Q 10/063114; G06F 3/0485; G06F 3/04847; G06F 3/0482

(57) ABSTRACT

A mobile computer device for browsing one or more internet content by a user, said mobile computing device comprising: one or more processors, the one or more processors executing an application embedded within said mobile computer device, said application comprising a date selection module, a time selection module, a service selection and display module, a work description module, a navigation initiation module, a worksite location address module, a user/contractor location beacon module, a pathfinding module, a worksite GPS location module, and the job/phase initiation module; wherein said date selection module allows a contractor to view a job dates as set and specified by an user; wherein said time selection module allows said contractor to view a job time as set and specified by said user; wherein said service selection and display module displays the job in which said user has specified that said contractor to perform; wherein said navigation initiation module interacts with said user/contractor location beacon, said pathfinding module, and said worksite GPS location to generate the fastest possible path for said contractor to get to said worksite; wherein job initiation module may not be activated until said contractor's beacon is within said worksite.

### FIELD OF INVENTION

This present invention is directed generally to a system and method of service personnel tracking through a UI interface utilizing global positioning system technology.

### BACKGROUND OF THE INVENTION

Today, the real estate market often is a hot topic regarding capital acquisition, either through avenues such as property development, house flipping through foreclosure purchases, or short-term rentals. People with some disposable income often look for ways to increase the amount of cash they have flowing into their accounts and investing into real estate has become an increasingly popular avenue to achieve those means. Oftentimes, these real estate investment opportunities require extensive construction in order to be viable for renting or for resale. This construction can range from flooring, roofing, drywalling, plastering, painting, excavation, demolition, etc. It is very likely the new purchasers of such an investment property do not have the requisite expertise in these fields to complete the extensive construction needed to turn the property to a profitable venture. Rather, they call construction contractors for each type of construction to help complete the project.

Contractors and handymen have been used for hundreds of years to complete jobs in construction, engineering, architecture, etc. Originally, to obtain a contractor, one must have known of the contractor personally or have known of people who had regular contact with such contractors. Word of mouth and posted writings were the primary sources of disseminating information about both the contractor's services and customer's construction needs. This was before the advent of technology which would allow for greater reach in advertising such services.

Back in the medieval and renaissance eras, the way to contract someone to do construction work for you was through an artisan guild. These guilds were dependent on the granting of letters patent from a monarch or another ruler to retain ownership of tools and the supply of materials, but mostly they were regulated by the city government. One had to be in the “know how”, in order to contract these guild members for construction purposes and often had to have some political power, in order to have access to these services.

In modern times, professional organizations replicate these guild structures and operation. Much engineering, construction, land surveying, etc. require varying lengths of apprenticeships before one can gain a professional certification. These organizations may post listings of their respective professionals as a way to help advertise these services to the general public or those who wish to visit these websites.

Nowadays, people can use their cellphones to call up construction contractors to obtain quotes and estimates on a potential project. They can hear about these servicemen through multiple new avenues such as social media, television adverts, online solicitations, and many more ways that modern technological advancements have unlocked. People interested in pursuing a construction project may delve into certain websites on the internet in order to scour the web for a such a contractor. There may be websites or certain internet hubs that harbor the contact information, work experience, and pay rates of such contractors, as well as their work locale.

Furthermore, it is possible to locate such construction contractors through specific recruitment websites such as ZipRecruiter or Jobble, in which one can find a candidate to fulfill their construction needs. This is done by entering in specifications for the type of job that one is looking to have completed and the computer algorithm matching the user with a serviceman that is available for the specifications selected. From there, a list of contractors will appear in which the user may select to contact for continuing his or her construction endeavors.

All of the foregoing methods and avenues for seeking and hiring construction personnel, as well as many others, are devised to assist in easing the process of searching for a suitable candidate by creating a more streamlined process and/or application. These applications employ easy-to-use UI interfaces that engage the user's visual senses and thus keep them active in navigating such application. They provide visual cues that allow the user to have greater insight and understanding on which contractors they wish to hire due to application features such as ratings, past job descriptions, reviews, etc. Further, they may also send notifications to users about potential candidates based on users preferences, demands, or interests.

However, certain problems exist in these current applications that may be remedied by innovation in this field. For example, one potential problem is that one who uses these applications has no idea of the whereabouts of his contractor that he hired. That user might not have any indication on what supplies the contractor has picked up, where the contractor was at certain hours, and what work was done on which work site. To remedy this issue, a tracking system utilizing global positioning systems may be used in order to meet all of these objectives.

### OBJECT OF THE INVENTION

Accordingly it is an object of this invention to provide an innovative system and method for gathering location-based data on contractor movement.

It is an object of the invention to provide an innovate system and method for establishing digital worksites to be viewed by both user and contractors.

It is another object of this invention to provide an innovative system and method of tracking hours worked on a particular construction job.

It is another object of this invention to provide an innovative system and method of algorithm-based computation of compensation earned, if utilizing a per hour-based pay system.

It is another object of this invention to provide an innovative system and method of streamlining the acquisition of construction-based services.

It is another object of this invention to provide an innovative system and method of pre-configuring worksite boundaries and time or location-based restrictions on starting and ending certain jobs.

### SUMMARY OF INVENTION

In the present invention, a construction freelance/contractor system is used to access a global positioning systems-based method of servicemen tracking, comprising an application embedded within the system, this application comprising: a worksite sketch module wherein the user may sketch upon a map image for worksite designation; a date and time window designation module wherein the user may preset or alter specific time windows that work may or must be accomplished; a coordinate positioning module that uses global positioning systems to track the movement of contractors and allows activation of worksites and job starts and ends

In one embodiment, the user manually selects locations and either freehand sketches or selects preset sketches to determine an area suitable for the worksite. In another embodiment, the worksite shape is preconfigured, allowing the user only to have control on the determination of its location. In one embodiment, this worksite may allow the user to preschedule time for contractor arrival and/or alter time frames in which the contractor should be working. In this embodiment, the contractor may be given a notice that the time frames available to work on a construction project has been altered.

In one embodiment, the contractor can or must start the job within the designated worksite to start the running of the clock for his or her hourly pay rate. In another embodiment, the contractor can or must start the job within the designated worksite, although pay is based on a fixed amount, for the purposes of tracking and time management. In one embodiment, there may be multiple worksites that may be designated for a particular single type of job. In another embodiment, there may be multiple worksites that have separate jobs for each site. In yet another embodiment, there may be groups of particular jobs for one worksite while there are groups of other particular jobs for another worksite.

In one embodiment, the date and time module might be preconfigured alongside the coordinate positioning module to restrict particular jobs at certain worksites on particular days. In this embodiment, a user may preconfigure a schedule which restricts and subsequently unlocks certain worksites on a day to day basis, such as job one at worksite one on day one and then job two on worksite two on day two, etc. An aspect of the invention disclosed is a mobile computer device for browsing one or more internet content by a user, the mobile computing device comprising: one or more processors, the one or more processors executing an application embedded within the mobile computer device, the application comprising a content display module comprising a date selection module, a time selection module, a service selection and display module, a work description module, a navigation initiation module, a worksite location address module, a user/contractor location beacon module, a pathfinding module, a worksite GPS location module, and the job/phase initiation module; wherein the date selection module allows a contractor to view a job dates as set and specified by an user; wherein the time selection module allows the contractor to view a job time as set and specified by the user; wherein the service selection and display module displays the job in which the user has specified that the contractor to perform; wherein the navigation initiation module interacts with the user/contractor location beacon, the pathfinding module, and the worksite GPS location to generate the fastest possible path for the contractor to get to the worksite; wherein job initiation module may not be activated until the contractor's beacon is within the worksite. In one embodiment, the job initiation module may not be activated until the contractor's beacon is within the worksite and when the actual date and time is consistent with the job dates and the job times. In one embodiment, the entirety of the content display module can be viewed by the user without the use of scrolling. In one embodiment, the entirety of the content display module can only be viewed by the user with the use of scrolling. In another aspect of the invention disclosed is mobile computer device for browsing one or more internet content by a user, the mobile computing device comprising: one or more processors, the one or more processors executing an application embedded within the mobile computer device, the application comprising a user/contractor location beacon module, a worksite GPS location module, and the job/phase termination module. In one embodiment, job termination module may not be terminated until the contractor's beacon is within the worksite. In one embodiment, the job termination module automatically activates when the contractor's beacon moves outside of the worksite.

### BRIEF DESCRIPTION OF THE INVENTION

The figures which accompany the written portion of this specification illustrate the embodiments and methods of use for the present disclosure, a service network utilizing global positioning system allowing customers to set and customize location-based worksites to track contractors and service personnel.

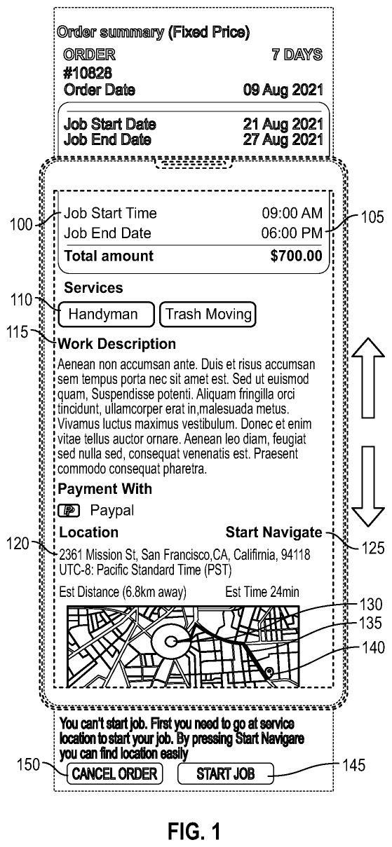

FIG. 1 depicts an illustration of an embodiment of the user interface from the business/contractor perspective displaying an order summary showing job dates, times, locations, services, global positioning systems maps, markers, and pathfinding, before the start of a job.

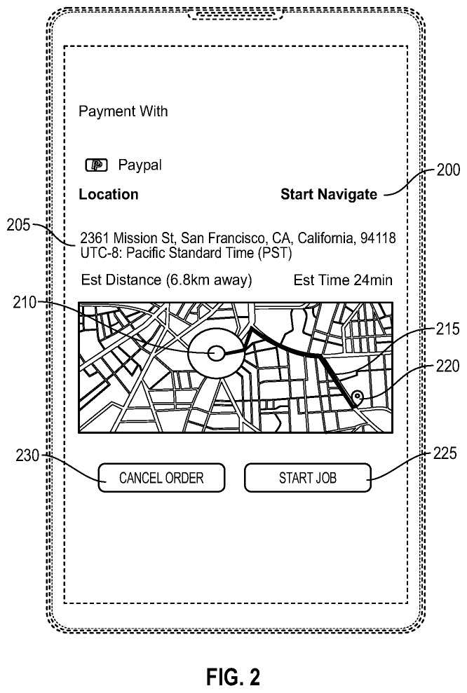

FIG. 2 depicts an illustration of an embodiment of the user interface from the business/contractor perspective after the start of a job.

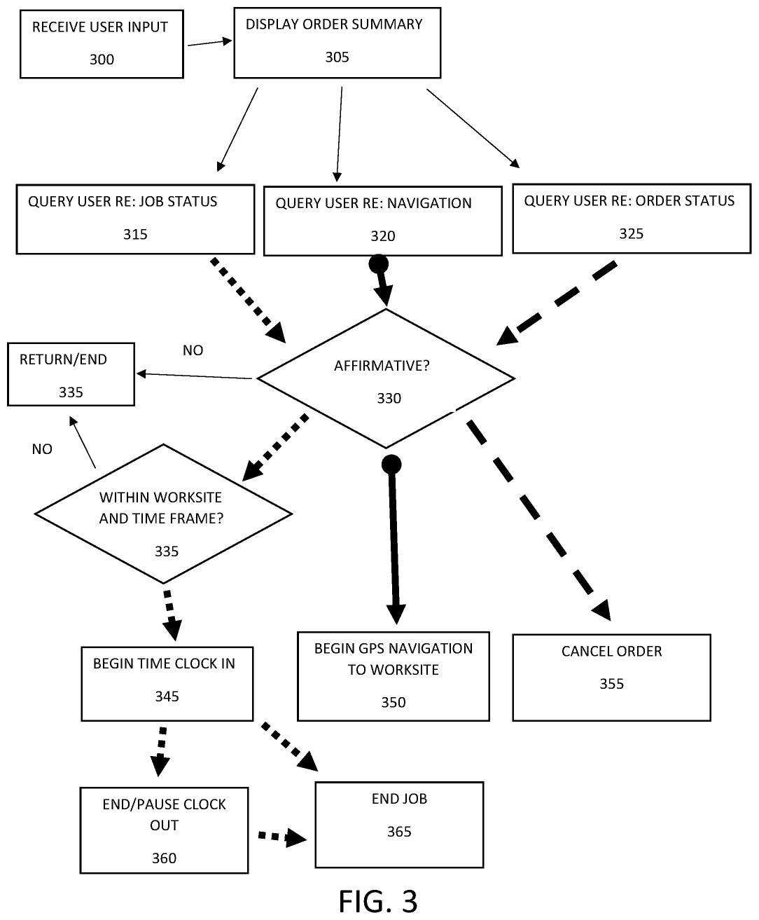

FIG. 3 depicts a diagram for explaining the functionality of the systems as depicted in FIG. 1 and FIG. 2.

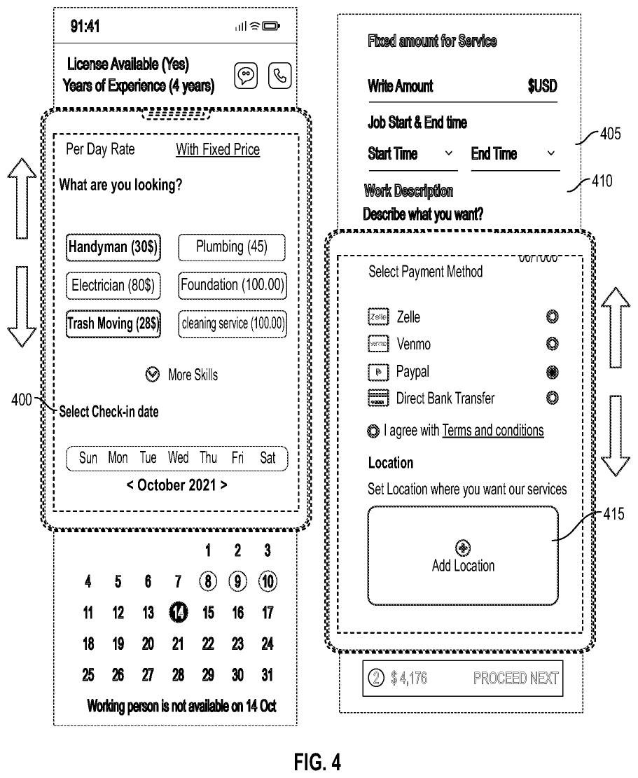

FIG. 4 depicts an illustration of an embodiment of the user interface from the consumer/user's perspective before the start of a job.

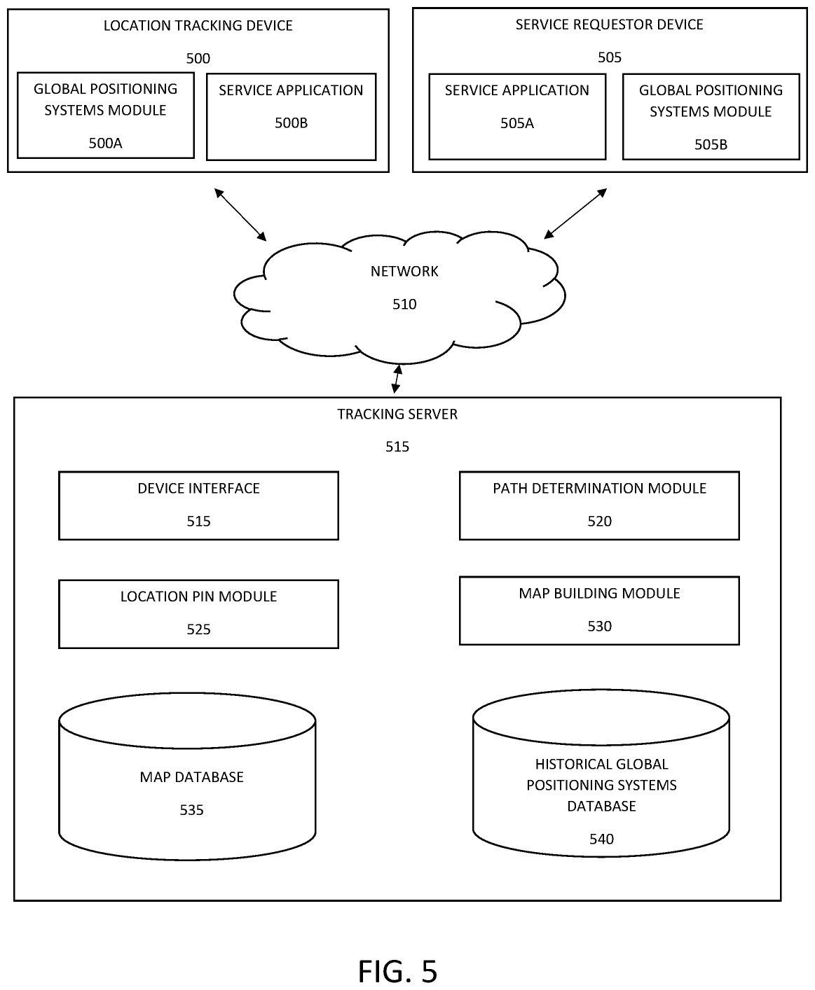

FIG. 5 depicts a diagram for explaining the functionality of global positioning systems and how they operate.

### DETAILED DESCRIPTION OF THE INVENTION

This disclosure is not limited to the particular systems, devices, methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the terms “comprising”, “including”, and/or “such as” mean “including, but not limited to.”

A “user” refers to one or more entities or people using any of the components and/or elements thereof described herein on the “user” or “consumer” side. In some embodiments, the user may be a layperson using the application and system for home renovations or investment property maintenance. In other embodiments, the user may be a private developer, seeking new or replacement contractors to help assist with large scale construction projects. In yet another embodiment, the user may be a contractor seeking to hire subcontractors for an existing project.

A “serviceman” or “contractor” refers to one or more entities of people using any of the components and/or elements thereof described herein on the “business” side. In some embodiments, the serviceman or contractor may be a single contractor listing his services for hire. In other embodiments, the serviceman or contractor may be a construction company or group listing multiple services for hire.

Referring to FIG. 1, an illustrative view of an embodiment of the current invention is shown, specifically a user interface of a mobile application consisting of a date selection module 100, a time selection module 105, a service selection and display module 110, a work description 115, a navigation initiation module 125, a worksite location address 120, a user/contractor location beacon 130, a pathfinding module 135, the worksite GPS location 140, and the job/phase initiation module 145. This illustrative view of this particular embodiment allows a serviceman/contractor to easily identify and engage with the user interface due to a clear and navigable screen. It is appreciated that the contractor can always customize the look-and-feel of the user interface and the application in general by using the provided configuration manager component of the application. The date selection module 100 allows a contractor to view the job dates as set and specified by the user. In one embodiment, this may be a set “chunk” of dates with no interruption between days. In this embodiment, the user may have specified that during this “chunk” of dates, the contractor must work every day for a certain minimum hour. Alternatively, the user may have specified that the contractor can work freely within that “chunk” of dates so long as the project is completed at the end of the job date. In another embodiment, the dates can be “staggered” as to not have one large chunk of dates, but rather the same job be done intermittently on different days of the week or even different weeks. In yet another embodiment, the user can specify that the contractor must be at different particular worksites on different days doing either the same or a different job. Similarly, the time selection module 105 operates in a similar manner to the date selection module, as it displays the time to begin and end a job as specified by the user/consumer. In one embodiment, the time frame may be “rigid” and automatically clock out the serviceman/contractor once the end time has been reached. In another embodiment, the time frame may purely serve a notice function, in which the contractor must still click the “end job” button 220 to complete that part of the job.

The service selection and display module 110 displays the services in which the user has specified that the contractor shall perform. In one embodiment, the listing of services purely functions as a display of what services are being performed. In another embodiment, the listing of services can be clicked on and descriptions of the work, including timesheets, work logs, etc., are displayed a secondary page. This may operate in sync with the work description 115, as clicking on the services may relocate the user/contractor to the relevant section of the work description as related to the service being performed. It is appreciated that one embodiment of the current invention will have the work description changed based on differing worksites and/or days, utilizing the global positioning systems database to check whether the contractor is within the zone of the worksite or not.

The navigation initiation module 120 interacts with the user/contractor location beacon 130, the pathfinding module 135, and the worksite GPS location 140 by creating the using an algorithm, analyzing traffic history and data, to generate the fastest possible path from the user/contractor's current location to the worksite location. It is appreciated that in one embodiment the navigation initiation module 120 operate with the existence of multiple worksite GPS locations 140 and use the pathfinding module 135 to create a path, stringing together the multiple worksite locations into one contiguous optimal plan. Additionally, the worksite location 125 serves to alert the user/contractor of the specific location of the worksite, so as to aid with visual guidance when approaching the proximity of the worksite.

In some embodiments the worksite GPS location 140 may be sketched out manually or freehand to create a large zone to classify as a worksite, provided that the project is a larger scale one. In other embodiments, the worksite GPS location 140 may be a preset shape or a “pin”, especially in the cases of a smaller scale project such as a renovation. The user is able to create such a worksite in which servicemen/contractors will be able to see it in a job posting after the worksite location is finalized. Further, it is appreciated that the worksite location can restrict or restrain particular worksites for particular days or particular types of work for particular worksites. Additionally, the job initiation module 145 may not be activated until the contractor's beacon 130 is within the zone of the worksite GPS location 140. In some embodiments, the job initiation module is manually triggered by the clicking or pressing of the “start job” button. In another embodiment, the job initiation module is automatically triggered upon contractor's beacon 130 fully entering the worksite GPS location 140. In one embodiment, the entirety of said content display module can be viewed by said user without the use of scrolling. In one embodiment, the entirety of said content display module can only be viewed by a said user with the use of scrolling. In some embodiments, the user interface of a mobile application exceeds the bounds of the screen of the mobile device such that a user would be able to access all the modules on the user interface by scrolling the screen up and down as necessary to access all the features on the interface.

Referring to FIG. 2, an illustrative view of an embodiment of the current invention after a job has been started is shown, consisting of a navigation initiation module 200, a worksite location address 205, a user/contractor beacon 210, a pathfinding module 215, a worksite GPS location 220, and a job/phase termination module 225. This illustrative view mirrors that of FIG. 1 with the main differentiation being that this view displays the user interface after a job or phase of a job has been completed. In this illustrative view of this particular embodiment of the current invention, the navigation initiation module 200, the worksite location address 205, the user/contractor beacon 210, the pathfinding module 215, and the worksite GPS location 220 are identical in function as seen in FIG. 1 as they are an extension/continuation of the ongoing process as seen in FIG. 1.

Regarding the job/phase termination module 225, it can be appreciated that one embodiment of the current invention will use such module to have the contractor manually terminate/end the job. In another embodiment, the job/phase termination module 225 is automatically triggered upon contractor's beacon 210 fully exiting the worksite GPS location 220. In yet another embodiment, the contractor must be within the worksite GPS location 220 to be able to terminate/end the job. In some embodiments, there exist phases to jobs rather than one job as a whole unit. In such embodiments, the terminating/ending of a phase does not complete the whole order, but rather completes one single unit of the project. For example, if a job requires five separate phases (such as roofing, flooring, plumbing, painting, electrical), then the completion of one phase will complete that specific unit of the project in the application. In some embodiments, the phases might represent a progression of the project and thus might be requirements to unlock the initiation 145 of subsequent phase. For example, if the roofing must be completed before the flooring, then absent the termination/end 225 of the roofing phase, the flooring phase of the project may not be initiated 145. In another embodiment, the phases do not represent a progression and are rather set up by the user to be independent phases of the same project. For example, the contractor can choose to either complete the flooring or painting first and the completion of one before the other has no bearing on the project as a whole.

Referring to FIG. 3, a flowchart of the processes and actions taken by clicking the buttons seen in FIG. 1 and FIG. 2. First the user input 300 is given by either a user/consumer or a serviceman/contractor to elicit the order, to which the order summary 305 is then displayed on the screen of the user's device. From here, the user has a multitude of options and buttons that he or she may be able to press. The user or contractor may affirmatively click 330 the Query User Re: Job Status 315, Query User Re: Navigation 320, or Query User Re: Order Status 325 buttons to choose a particular action. Clicking of the Query User Re: Job Status 315 action via the job initiation module 145 or the job termination module 225 will cause the job status to switch from either an active to inactive state. Upon commencing the action 315, the application will use global positioning systems technology as seen in FIG. 5 to determine whether the user or contractor's beacon 130 is within the specified worksite 140. If the user or contractor beacon 130 is not within the specified worksite 140, the action will cease and the screen display will revert back to the user interface as seen in either FIG. 1 or FIG. 4 depending on whether the person utilizing the app is a serviceman/contractor or a user/consumer. If the user or contractor beacon 130 is within the specified worksite 140, the time clock will start running and begin actively tracking the GPS location device 500 of the contractor as well as managing a time sheet, with the status of the contractor as “currently working”. In some embodiments, for a short project, after finishing up the work for the day and thus the project in its entirety, the contractor may affirmatively click 300 the Query User Re: Job Status 315 action via the job termination module 225 to complete the job 365. In another embodiment, the project may be longer and over many weeks or months. In this case, the system of the application would recognize that the entirety of the project is not yet completed and rather have the action 315 via the module 225 to pause or clock out of the job in place of ending it. From there, the contractor can continue to repeat the action 315 via the job initiation module 145 at the start of the working day and via the job termination module 225 at the end of the day to essentially pause and resume 360 the contractor's status as “currently working”. At the final phase of the project, the contractor may then affirmatively click 300 the Query User Re: Job Status 315 action via the job termination module 225 to complete the job 365.

The user or contractor may also affirmatively click 330 Query User Re: Navigation 320 action via the navigation module 125 in order to begin the pathfinding module 135 to locate the nearest and fastest way to get to the destination of the specified worksite GPS location 140 and begin global positioning systems navigation to the specified worksite 350. The user or contractor may also affirmatively click 330 the Query User Re: Order Status action via the order cancellation module 150 to cease all operations regarding the job and cancel the order 355. In some embodiments, this feature is only available to contractors before they the user or contractor may affirmatively click 330 the Query User Re: Job Status action 315 via the job initiation module 145 to start the job.

The user/consumer may also contractor may also affirmatively click 330 the Query User Re: Order Status action via the order cancellation module 230 to cease all operations regarding the job. In some embodiments, the user may be able to cancel the order 355 at any given time, however he or she would forfeit the monies paid for the job to be completed. In other embodiments, a deposit amount could have been placed in the case of a hire on a hour-hour or day-day basis. It any of these aforementioned actions are not affirmatively clicked, the screen display will revert back 335 as seen in either FIG. 1 or FIG. 4 depending on whether the person utilizing the app is a serviceman/contractor or a user/consumer.

Referring to FIG. 4, an illustrative view of an embodiment of the current invention in the perspective of the user/consumer is shown, consisting of a date selection module 400, a time selection module 405, a work description 410, and a worksite GPS location selection module 415. In this illustrative view of his embodiment, the user/consumer is able to specify a date or multiple dates using the date selection module 400 to alert potential servicemen/contractors of the dates the contract/project will undergo. As mentioned previously, this date selection module 400 may allow the user/consumer to specify projects for lasting certain “chunks” of days rather than one contiguous project. For example, the user/consumer may specify projects to be worked on intermittently throughout a year, during specific weekends of specific months. The time selection module 405 allows the user/consumer to specific the specific times that the potential servicemen/contractors shall work. Further, it serves as a restriction, in the sense that servicemen/contractors may not start the job/their time clock on the application until their device is physically present at the worksite GPS location 220.

From the user/consumer side, the worksite GPS location selection module 415 may be used to create the worksite in which the contractor may activate the job initiation module 145. As aforementioned, in some embodiments, this worksite location may be manually and freehand sketched to accurately portray large parcels of land and/or oddities in the real estate. In other embodiments, this worksite location may be a fixed preset shape that is merely dragged over the map and planted onto it. The details of such embodiments are located above in the preceding sections. The user/consumer may press this GPS location selection module 415 after creating one to revise a saved draft of the location. Further, the user/consumer may edit the location once the job has been laid out onto the digital marketplace. From here, in some embodiments, the user/consumer may be able to edit the locations and communicate with the serviceman/contractor about such relocation. In some embodiments, the user interface of a mobile application exceeds the bounds of the screen of the mobile device such that a user would be able to access all the modules on the user interface by scrolling the screen up and down as necessary to access all the features on the interface.

Referring to FIG. 5, a diagram showcasing GPS technology is shown. Starting from a location tracking device 500 such as a phone or other mobile device, a service application 500B is used such as a pre-installed navigation map on the device in which a global positioning systems module 500A is installed. Concurrently, a service requestor device 505 is used in which a service application 505A is running alongside a global positioning systems module 505B. In some embodiments the service requestor device may be a computer server system setup by an internet communications company in their navigation department. Subsequently both the location tracking device 500 and the service requestor device 505 relay backend communications to one another through the internet or other applicable network 510 which then finds its way into a tracking server 515 containing multiple elements including, but not limited to a device interface 515, a path determination module 520, a location pin module 525, a map building module 530, a map database 535, and a historical global positioning systems database 540.

The device interface 515 displays the location pin module 525 and employs the path determination module 520 as well as the map building module 530 to construct the fastest possible legal route to the destination from the GPS user's current position. Further, it utilizes the map database 535 to cross analyze differing maps in order to establish the most accurate map for the user to correctly display locations such as restaurants, offices, parks, etc. Additionally, a historical global positioning systems database 540 is utilized in order to determine variables such as traffic, undergoing construction, etc. in order to create a smoother ride and experience for the user.

In the above detailed descriptions, reference is made to the accompanying drawings and photos, which form a part hereof. The photos and drawn design schematic are not meant to be limiting. Other embodiments may be used, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and Scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the sin gular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open terms (for example, the term “including should be interpreted as “including but not limited to the term “having should be interpreted as “having at least the term “includes should be interpreted as “includes but is not limited to etcetera). While various compositions, methods, and devices are described in terms of “comprising various components or steps (interpreted as meaning “including, but not limited to’), the compositions, methods, and devices can also “consist essentially of or “consist of the various components and steps, and Such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one’ and “one or more’ to introduce claim recitations. However, the use of such phrases should not be construed to imply that the introduction of a claim recitation by the indefinite articles ‘a’ or “an limits any particular claim containing Such introduced claim recitation to embodiments containing only one Such recitation, even when the same claim includes the introductory phrases “one or more’ or “at least one’ and indefinite articles such as “a” or “an’ (for example, “a” and/or “an should be interpreted to mean “at least one’ or “one or more’); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations.” without other modifiers, means at least two recitations, or two or more recitations). Furthermore, in those instances where a convention analogous to “at least one of A, B, and C, et cetera’ is used, in general Such a construction is intended in the sense one having skill in the art would understand the convention (for example, “a system having at least one of A, B, and C would include but not be limited to systems that have A alone, B alone, C alone, A and B together, A and C together, B and C together, and/or A, B, and C together, et cetera). In those instances where a convention analogous to “at least one of A, B, or C, etcetera” is used, in general such a construction is intended in the sense one having skill in the art would understand the convention (for example, “a system having at least one of A, B, or C would include but not be limited to systems that have A alone, B alone, C alone, A and B together, A and C together, B and C together, and/or A, B, and C together, et cetera). It will be further understood by those within the art that virtually any disjunctive word and/or Mar. 31, 2016 phrase presenting two or more alternative terms, whether in the description, claims, or drawings, should be understood to contemplate the possibilities of including one of the terms, either of the terms, or both terms. For example, the phrase “A or B will be understood to include the possibilities of “A” or B Or A and B.

Various of the above-disclosed and other features and functions, or alternatives thereof, may be combined into many other different systems or applications. Various presently unforeseen or unanticipated alternatives, modifications, variations or improvements therein may be Subsequently made by those skilled in the art, each of which is also intended to be encompassed by the disclosed embodiments.

The invention claimed is:

1. A mobile computer device for browsing one or more internet content by a user, said mobile computing device comprising: one or more processors, the one or more processors executing an application embedded within said mobile computer device, said application comprising:
a. a content display module comprising a date selection module, a time selection module, a service selection and display module, a work description module, a navigation initiation module, a worksite location address module, a user/contractor location beacon module, a pathfinding module, a worksite GPS location module, and the job/phase initiation module;
b. wherein said date selection module allows a contractor to view a job dates as set and specified by an user;
c. wherein said time selection module allows said contractor to view a job time as set and specified by said user;
d. wherein said service selection and display module displays the job in which said user has specified that said contractor to perform;
e. wherein said navigation initiation module interacts with said user/contractor location beacon, said pathfinding module, and said worksite GPS location to generate the fastest possible path for said contractor to get to said worksite;
f. wherein job initiation module may not be activated until said contractor's beacon is within said worksite.

2. The application of claim 1 wherein said job initiation module may not be activated until said contractor's beacon is within said worksite and when the actual date and time is consistent with said job dates and said job times.

3. The application of claim 1 wherein the entirety of said content display module can be viewed by said user without the use of scrolling

4. The application of claim 1 wherein the entirety of said content display module can only be viewed by said user with the use of scrolling.

5. A mobile computer device for browsing one or more internet content by a user, said mobile computing device comprising: one or more processors, the one or more processors executing an application embedded within said mobile computer device, said application comprising:
g. a user/contractor location beacon module, a worksite GPS location module, and the job/phase termination module.

6. The application of claim 3 wherein job termination module may not be terminated until said contractor's beacon is within said worksite.

7. The application of claim 3 wherein job termination module automatically activates when said contractor's beacon moves outside of said worksite.
